(19) United States
(12) Patent Application Publication
(10) Pub. No.: US 2014/0372062 A1
(43) Pub. Date: Dec. 18, 2014

(54) CALIBRATION METHOD AND CALIBRATION TOOL FOR IN-MOLD MOLTEN METAL LEVEL METER

(71) Applicant: SHINAGAWA REFRACTORIES CO., LTD., Chiyoda-ku (JP)

(72) Inventors: Manabu Arai, Chiyoda-ku (JP); Masayuki Nakada, Chiyoda-ku (JP)

(73) Assignee: SHINAGAWA REFRACTORIES CO., LTD., Chiyoda-ku (JP)

(21) Appl. No.: 14/116,097

(22) PCT Filed: Jun. 18, 2013
(86) PCT No.: PCT/JP13/66721

§ 371 Date: Nov. 6, 2013

(51) Int. Cl. G01F 25/00; B22D 46/00

(52) U.S. Cl. CPC G01F 25/0061; B22D 46/00
USPC 702/100

(57) ABSTRACT

A length from a lower end position of the detection head (11) to a measurement lower limit of the detection head (11) is divided by height positions separated with a predetermined interval pitch. A plurality of virtual level plates (40) are prepared to be placed respectively at the height positions separated with a predetermined interval pitch such that gaps between themselves and each wide face of the mold (1) are not larger than 2 mm respectively at the height positions. Calibration is carried out while using each of the virtual level plates (40) at a corresponding one of the height positions.

### TECHNICAL FIELD

The present invention relates to a calibration method and calibration tool for an in-mold molten metal level meter configured to measure the molten metal level inside a mold used for continuous casting.

### BACKGROUND ART

In the case of continuous casting, it is possible to improve the quality of cast pieces by measuring the molten metal level inside a mold with high accuracy and controlling the molten metal level to be constant. From this point of view, in-mold molten metal level meters operable with high accuracy are being developed.

Conventionally, as an in-mold molten metal level meter of this kind, an eddy current type distance meter described in Patent Document 1 is known.

The eddy current type distance meter disclosed in Patent Document 1 comprises a sensor formed of a primary coil and a pair of secondary coils concentrically disposed respectively above and below the primary coil and differentially connected to each other; an amplifier configured to amplify the AC (alternative current) voltage from an oscillator and apply it to the primary coil; and a signal amplifier configured to amplify the difference output voltage of the pair of secondary coils and feed it back to the above-mentioned amplifier.

According to Patent Document 1, the sensor coils include the secondary coils concentrically and separately disposed on upper and lower sides, such that the secondary coils are differentially connected to each other to obtain a feedback signal, and detection sensitivity is thereby retained only in the axial direction of the secondary coils. In this case, the influence of side electrical conductors are removed by the separated secondary coils that make compensation for it, and temperature variations are offset also by the separated secondary coils. Consequently, the eddy current type distance meter becomes better in characteristic and is thereby improved in measurement accuracy.

Incidentally, when this eddy current type distance meter is actually put to use, it requires a calibration operation. Specifically, a detection head including a sensor contained in a casing is used, and the length from the lower end of the detection head to the measurement lower limit of the detection head is divided by positions separated with a pitch of 10 mm. A virtual level plate made of stainless steel is placed at each of these positions, and the output voltage of the feedback amplifier obtained by use of the virtual level plate placed at each of the positions is recorded to carry out calibration. When casting is taking place, the distance from the lower end of the detection head to the molten steel surface is derived by calculating backward from a measurement output voltage of the feedback amplifier.

Conventionally, a calibration apparatus shown in FIG. 1 is used for this calibration operation. Specifically, a detection head 102 including a sensor contained in a casing is fixed inside a mold 101, and a virtual level plate 103 made of stainless steel is suspended by a calibration tool 104 inside the mold 101. The virtual level plate 103 is moved up and down by rotating a handle (not shown) attached to the calibration tool 104, while a counter and dial gauge 105 is used at the same time to measure its movement in the vertical direction.

### PRIOR ART DOCUMENT

### Patent Document

[Patent Document 1]
Jpn. Pat. Appln. KOKOKU Publication No. 62-30562

### SUMMARY OF INVENTION

However, according to the conventional calibration method described above, the virtual level plate 103 has a constant size, and thereby brings about such a situation in the case of a mold having a large taper, e.g., a thin slab continuous casting machine, that the gap between the virtual level plate 103 and the corresponding wide face of the mold 101 becomes so large as more than 2 mm, depending on the distance from the detection head. Accordingly, even if the virtual level plate 103 and a molten steel surface in actual casting are exactly the same as each other about the distance from the lower end of the detection head 102, they may render different values in the output voltage of the positive feedback amplifier. Specifically, since the virtual level plate 103 has an area smaller than the molten steel surface, generation of the eddy current decreases and the output voltage of the positive feedback amplifier increases. Consequently, the true distance from the lower end of the detection head to the molten steel surface becomes different from the measurement distance indicated by the sensor of the in-mold molten metal level meter.

Accordingly, an object of the present invention is to provide a calibration method and calibration tool for an in-mold molten metal level meter, which can make errors smaller in the molten metal level signal measured by the in-mold molten metal level meter even when the mold has a large taper.

Specifically, the present invention provides a calibration method for an in-mold molten metal level meter that includes an oscillator configured to transmit an AC signal having a predetermined frequency, a feedback amplifier configured to be supplied with the AC signal, and a detection head including a primary coil and a pair of secondary coils differentially connected to each other, wherein the in-mold molten metal level meter is configured to supply an output of the feedback amplifier to the primary coil, and feed back an output of the secondary coils to the feedback amplifier, so as to measure a molten metal level inside a mold based on an output of the feedback amplifier, which varies in response to a change in the molten metal level, the method comprising: dividing a length from a lower end position of the detection head to a measurement lower limit of the detection head by height positions separated with a predetermined interval pitch; preparing a plurality of virtual level plates configured to be placed respectively at the height positions separated with a predetermined interval pitch such that gaps between themselves and each wide face of the mold are not larger than 2 mm respectively at the height positions; and carrying out calibration while using each of the virtual level plates at a corresponding one of the height positions.

Further, the present invention provides a calibration tool for an in-mold molten metal level meter that includes an oscillator configured to transmit an AC signal having a predetermined frequency, a feedback amplifier configured to be supplied with the AC signal, and a detection head including a primary coil and a pair of secondary coils differentially connected to each other, wherein the in-mold molten metal level meter is configured to supply an output of the feedback amplifier to the primary coil, and feed back an output of the secondary coils to the feedback amplifier, so as to measure a molten metal level inside a mold based on an output of the feedback amplifier, which varies in response to a change in the molten metal level, the tool comprising: virtual level plate holding devices each configured to hold a virtual level plate and respectively disposed at height positions separated with a predetermined interval pitch, which divide a length from a lower end position of the detection head to a measurement lower limit of the detection head; and a plurality of virtual level plates configured to be placed respectively at the height positions separated with a predetermined interval pitch such that gaps between themselves and each wide face of the mold are not larger than 2 mm respectively at the height positions, so as to carry out calibration while using each of the virtual level plates at a corresponding one of the height positions.

According to the present invention, the output voltage of the feedback amplifier obtained by use of each of the virtual level plates shows a value closer to the output voltage of the feedback amplifier obtained relative to the molten steel surface at the same position. Consequently, it is possible to decrease the error in the molten metal level signal measured by the in-mold molten metal level meter even if the mold has a large taper.

### BRIEF DESCRIPTION OF DRAWINGS

FIG. 1 This is a view showing a conventional calibration apparatus for an in-mold molten metal level meter.

FIG. 2 This is a view showing an in-mold molten metal level meter used in an embodiment of the present invention.

FIG. 3 This is a perspective view showing a calibration tool used in a calibration method for an in-mold molten metal level meter according to an embodiment of the present invention.

FIG. 4 This is a view showing the relationship of the output voltage of the in-mold molten metal level meter with the gap between the virtual level plate and mold wide face.

FIG. 5 This is a view showing results obtained by the present invention and the conventional technique in terms of the relationship of the measurement value of the sensor (in-mold molten metal level meter) with the true distance from the lower end of the detection head to the molten steel surface.

### EMBODIMENT FOR CARRYING OUT THE INVENTION

An embodiment of the present invention will now be described with reference to the accompanying drawings.

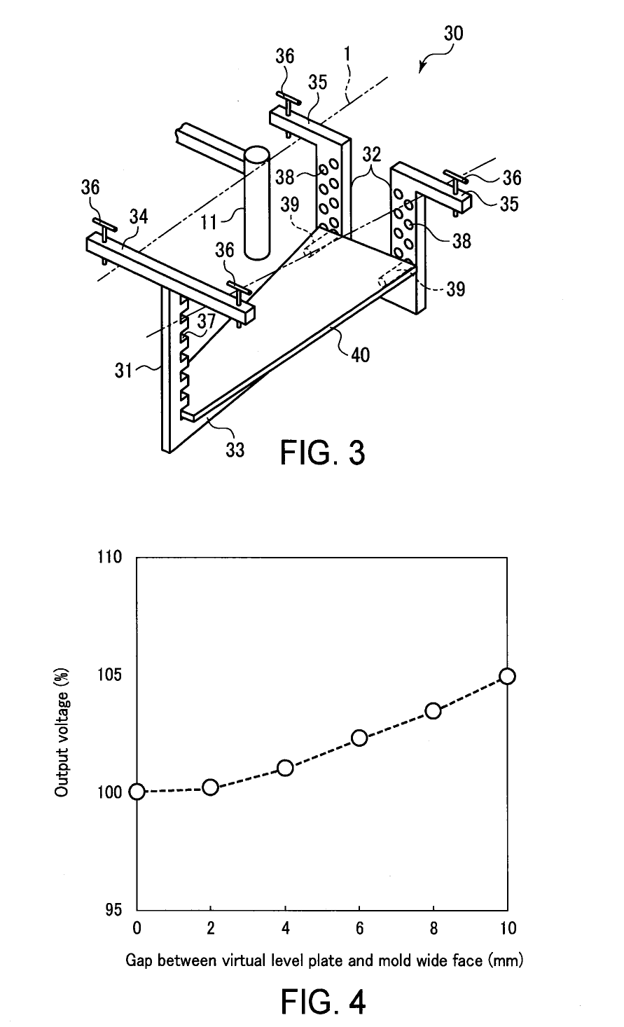

FIG. 2 is a view showing an in-mold molten metal level meter used in an embodiment of the present invention. FIG. 3 is a block diagram. In FIGS. 2 and 3, the reference symbol 1 denotes a mold for continuous casting.

The in-mold molten metal level meter 20 is designed as an eddy current type distance meter, which comprises an oscillator 3 configured to transmit an AC signal having a predetermined frequency; a feedback amplifier 4 configured to be supplied with the AC signal thus transmitted; a detection head 11; and a signal amplifier 10.

The detection head 11 is disposed above the molten steel surface 2 inside the mold 1, and is structured with a sensor 5 contained in a casing. The sensor 5 includes a primary coil 7 wound around a coil bobbin 6 and serving as a transmitter coil, and a pair of secondary coils 8 and 9 concentrically disposed and serving as receiver coils. The pair of secondary coils 8 and 9 are differentially connected to each other. The primary coil 7 is supplied with an AC voltage having a fixed frequency from the oscillator 3 through the feedback amplifier 4, so that an AC magnetic field is generated to be across the secondary coils 8 and 9 and to be also across the molten steel, and an eddy current is thereby generated in the molten steel at the surface. Due to a counteraction of the eddy current, an AC magnetic field having the reverse polarity is generated, and voltages are respectively induced in the pair of secondary coils 8 and 9 by this counteraction. The difference of these inductive voltages is amplified by the signal amplifier 10, and then it is fed back to the feedback amplifier 4 and output as an output voltage E₀.

According to the in-mold molten metal level meter 20 designed as described above, the detection head 11 is set up above the molten steel surface 2 inside the mold 1, and an AC voltage having a fixed frequency is supplied to the primary coil 7 of the detection head 11 from the oscillator 3 through the feedback amplifier 4. Consequently, an AC magnetic field is generated. This AC magnetic field intersects the secondary coils 8 and 9 serving as receiver coils and also intersects the molten steel inside the mold 1 to generate an eddy current at the molten steel surface. Due to a counteraction of the eddy current thus generated, an AC magnetic field is generated to have a polarity reverse to that generated from the primary coil 7 serving as a transmitter coil, and the inductive voltages induced in the pair of secondary coils 8 and 9 vary by the influence of the AC magnetic field. Since this influence affects more the secondary coil 9 that is closer to the molten steel surface 2, the inductive voltages V_{S1} and V_{S2} in the pair of secondary coils 8 and 9 satisfy V_{S1}>V_{S2}. This difference V_{S}=(V_{S1}−V_{S2}) is supplied to the signal amplifier 10 and amplified to a predetermined extent, and then it is fed back to the feedback amplifier 4.

Accordingly, the output of the feedback amplifier 4 is expressed by the following formula (I),

E₀=−G1·Eᵢₙ/{1−G1(K+G2·f(h))} (1)

where

E₀; the output voltage of the feedback amplifier 4,

Eᵢₙ; the output voltage of the oscillator 3 (the input voltage of the feedback amplifier 4),

G1; the open amplification rate of the feedback amplifier 4,

G2; the amplification rate of the signal amplifier 10,

K; the positive feedback rate, and

f(h); a function (expressed by f(h)=V_{S}/E₀) determined by the relative distance between the sensor 5 and the molten steel surface 2.

Accordingly, as apparent from the formula (I), when G1, G2, and Eᵢₙ are fixed, the value of the output voltage E₀ varies depending on the relative distance between the sensor 5 in the detection head 11 and the molten steel surface 2. Thus, measuring this value can be to measure the level of the molten steel surface 2.

When the in-mold molten metal level meter 20 is actually put to use, it requires a calibration operation. Accordingly, a calibration tool 30 shown in FIG. 3 is used for the calibration.

The calibration tool 30 is designed to utilize virtual level plates 40 made of stainless steel. Each virtual level plate 40 is placed at the corresponding one of the positions dividing a known length with a predetermined pitch from the lower end of the detection head 11. The output voltage E₀ of the feedback amplifier 4 of the in-mold molten metal level meter 20 obtained by use of each virtual level plate 40 placed at the corresponding position is recorded to carry out calibration. When casting is taking place, the distance from the lower end of the detection head 11 to the molten steel surface is derived by calculating backward from a measurement output voltage of the feedback amplifier 4.

Specifically, the calibration tool 30 is designed to extend along the mold 1 from the top to the inside of the mold 1, and it includes a first holding portion 31 and a second holding portion 32 connected to each other at their lower ends by a connecting portion 33 and configured to hold the virtual level plates 40. The first holding portion 31 and the second holding portion 32 are respectively connected to support members 34 and 35 at their upper ends, by which they can be suspended from the respective wide face portions of the mold 1. The support members 34 and 35 are equipped with pins 36 to perform fine adjustment of the horizontal level of the calibration tool 30.

The first holding portion 31 includes holding grooves 37 for holding the virtual level plates 40 with a predetermined pitch, such as a 10 mm pitch, from the lower end of the detection head 11 to the measurement lower limit of the detection head 11. On the other hand, the second holding portion 32 includes holding pin insertion holes 38 with the pitch corresponding to the holding grooves 37 in the depth direction of the mold 1, so that holding pins 39 can be respectively inserted into the holding pin insertion holes 38. The holding grooves 37 and the holding pin insertion holes 38 and holding pins 39 serve as virtual level plate holding devices.

Each virtual level plate 40 is held at predetermined one of the positions by a set of a holding groove 37 and holding pins 39 inserted in corresponding holding pin insertion holes 38. The output voltage E₀ of the feedback amplifier 4 of the in-mold molten metal level meter 20 obtained by use of each virtual level plate 40 placed at the corresponding position is recorded. This operation is performed for all of the positions separated with a predetermined pitch to carry out the calibration.

In the case of the conventional technique that carries out calibration by moving up and down a virtual level plate of a single type, if the mold has a large taper, the gap between the virtual level plate and the corresponding wide face of the mold becomes so large as more than 2 mm, depending on the distance from the lower end of the detection head.

In this respect, the output signal E₀ of the feedback amplifier 4 was measured, while the gap between a virtual level plate 40 and a wide face of the mold 1 was varied; which rendered the results shown in FIG. 4. In this example, the distance between the virtual level plate and the bottom of the detection head 11 was fixed at 50 mm, and only the width of the virtual level plate was changed to vary the gap between itself and the mold wide face. In this case, the detected level signal became larger along with the increase in the gap between the virtual level plate and the mold. This was so because the eddy current generated on the virtual level plate becomes smaller along with the increase in the gap. If the gap between the virtual level plate and the mold wide face exceeds 2 mm, the increase in the output signal becomes too large, and brings about a significant error in the molten metal level signal, as shown in FIG. 4.

On the other hand, as shown in FIG. 4, as long as the gap between the virtual level plate and the mold wide face is not larger than 2 mm, the molten metal level signal results in a value almost the same as that obtained when the gap is not at all present.

Accordingly, this embodiment pays attention to a case where the mold 1 has a taper and the distance between the wide faces of the mold varies depending on the height position. In light of such a case, the length from the lower end of the detection head 11 to the measurement lower limit of the detection head 11 is divided by height positions separated with a predetermined interval pitch. The virtual level plate holding devices (the holding groove 37, holding pin insertion holes 38, and holding pins 39) are respectively prepared at these height positions separated with a predetermined interval pitch. A plurality of virtual level plates 40 different in size are prepared such that the gaps between themselves and each of the wide faces of the mold 1 are not larger than 2 mm at the height positions respectively equipped with the virtual level plate holding devices. The virtual level plates 40 are used correspondingly at the height positions to carry out the calibration. At every height position, the gap between each of the virtual level plates 40 and each of the wide faces of the mold 1 is not larger than 2 mm. Consequently, even if a mold has a large taper, the molten metal level signal measured by the in-mold molten metal level meter 20 comes to have a smaller error.

Specifically, each of the positions separated with a predetermined pitch, such as 10 mm pitch, can be provided with one of the virtual level plates 40, which forms a gap of 2 mm or less between itself and each of the wide faces of the mold 1. In this case, the output voltage of the feedback amplifier 4 obtained by use of the virtual level plate 40 shows a value closer to the output voltage of the feedback amplifier 4 obtained relative to the molten steel surface at the same position. Thus, the value measured by the in-mold molten metal level meter 20 as the distance from the lower end of the detection head 11 to the molten steel surface is closer to the true distance from the lower end of the detection head 11 to the molten steel surface. Consequently, it is possible to decrease the error in the molten metal level signal measured by the in-mold molten metal level meter 20.

Further, in this embodiment, the holding grooves 37 and the holding pin insertion holes 38 are formed in advance with a predetermined pitch, and each virtual level plate 40 is placed on a set of a holding groove 37 and holding pins 39 inserted in holding pin insertion holes 38. Consequently, the virtual level plate 40 can be easily set in parallel with the lower surface of the detection head 11. Further, the pin 36 can be utilized for fine adjustment to set the parallelism of the calibration tool 30, and so the calibration is achieved with high accuracy.

The present invention is not limited to the embodiment described above, and it may be modified in various manners. For example, the pitch of the virtual level plate holding devices is exemplified with 10 mm, but this is not limiting. Further, each of the virtual level plate holding devices is exemplified by a set of a holding groove 37 and holding pins 39 inserted in holding pin insertion holes 38, but the virtual level plate holding devices can take any form as long as they can hold virtual level plates with a predetermined pitch.

### Present Example

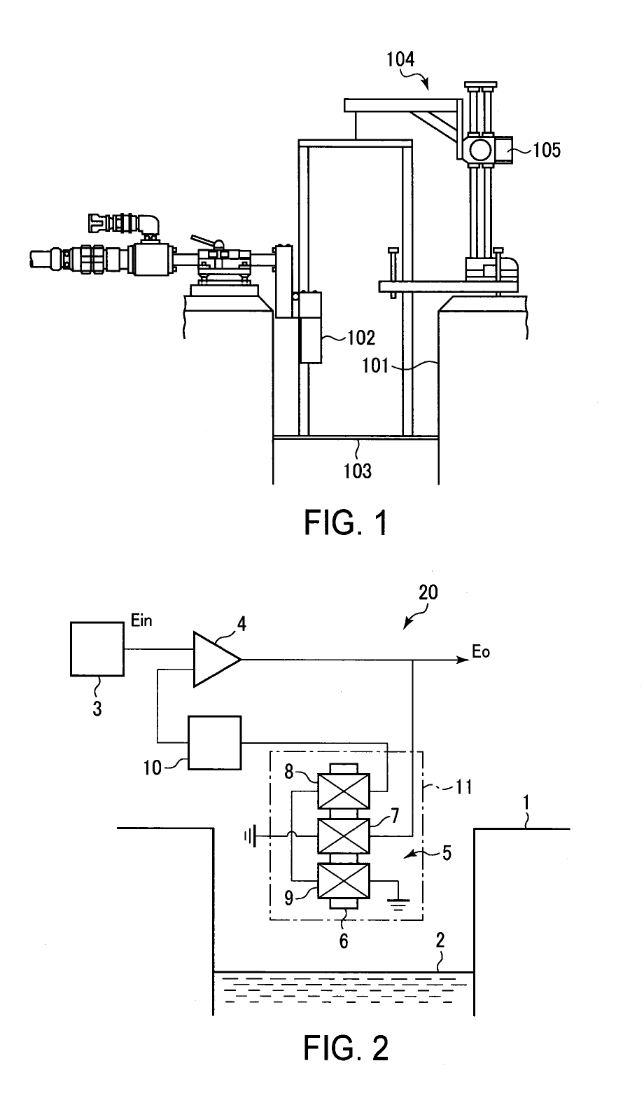

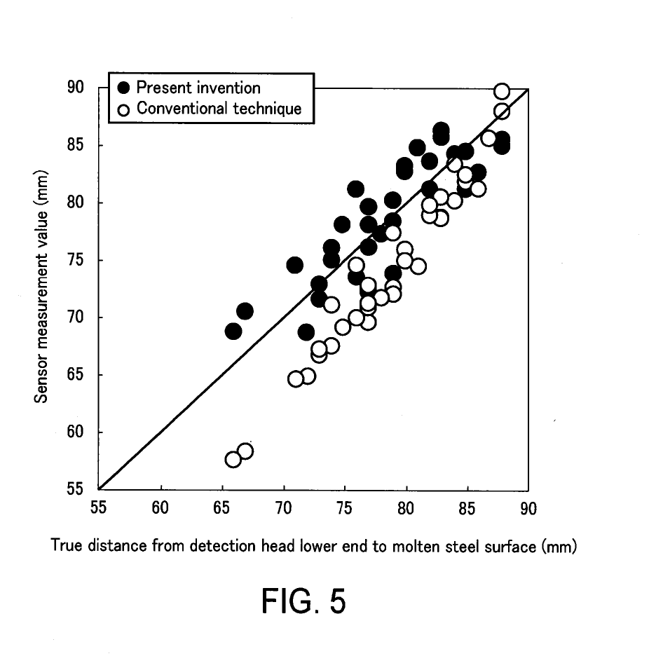

The mold of a continuous casting machine for steel was provided therein with an in-mold molten metal level meter the same in structure as the in-mold molten metal level meter 20 described above and acalibration tool the same in structure as the calibration tool 30 described above. As regards the in-mold molten metal level meter, the length from the lower end of the detection head to the measurement lower limit thereof was divided by positions separated with a 10 mm pitch. A plurality of virtual level plates were prepared respectively for the positions separated with the pitch such that the gaps between themselves and each of the wide faces of the mold were not larger than 2 mm. The sensor calibration was carried out while placing the virtual level plates respectively at these positions. Thereafter, actual casting was executed while the molten steel surface inside the mold was caused to vary within a range of 65 to 90 mm from the lower end of the detection head. Further, in order to measure the true distance from the lower end of the detection head to the molten steel surface, at a certain frequency, a piece of wire was vertically immersed into the molten steel surface to melt its distal end portion and then the length of the remaining portion was measured. FIG. 5 is a view showing the relationship between this true distance and the sensor measurement value of the in-mold molten metal level meter, while comparing it with results obtained by use of the conventional calibration method explained with reference to FIG. 1.

As shown in FIG. 5, when the conventionally arranged method was used, the sensor measurement value rendered large errors with a difference of 10 mm at the maximum relative to the true distance. On the other hand, when the calibration method according to the present invention was used, the sensor measurement value rendered results closer to the true distance from the lower end of the detection head to the molten steel surface.

### REFERENCE SYMBOLS LIST

1=mold; 2=molten steel surface; 3=oscillator; 4=feedback amplifier; 5=sensor; 6=coil bobbin; 7=primary coil; 8, 9=secondary coil; 10=signal amplifier; 11=detection head; 20=in-mold molten metal level meter; 30=calibration tool; 31=first holding portion; 32=second holding portion; 33=connecting portion; 34, 35=support member; 36=pin; 37=holding groove; 38=holding pin insertion hole; 39=holding pin; and 40=virtual level plate.

1. A calibration method for an in-mold molten metal level meter that includes an oscillator configured to transmit an AC signal having a predetermined frequency, a feedback amplifier configured to be supplied with the AC signal, and a detection head including a primary coil and a pair of secondary coils differentially connected to each other, wherein the in-mold molten metal level meter is configured to supply an output of the feedback amplifier to the primary coil, and feed back an output of the secondary coils to the feedback amplifier, so as to measure a molten metal level inside a mold based on an output of the feedback amplifier, which varies in response to a change in the molten metal level, the method comprising:
dividing a length from a lower end position of the detection head to a measurement lower limit of the detection head by height positions separated with a predetermined interval pitch; preparing a plurality of virtual level plates configured to be placed respectively at the height positions separated with a predetermined interval pitch such that gaps between themselves and each wide face of the mold are not larger than 2 mm respectively at the height positions; and carrying out calibration while using each of the virtual level plates at a corresponding one of the height positions.

2. A calibration tool for an in-mold molten metal level meter that includes an oscillator configured to transmit an AC signal having a predetermined frequency, a feedback amplifier configured to be supplied with the AC signal, and a detection head including a primary coil and a pair of secondary coils differentially connected to each other, wherein the in-mold molten metal level meter is configured to supply an output of the feedback amplifier to the primary coil, and feed back an output of the secondary coils to the feedback amplifier, so as to measure a molten metal level inside a mold based on an output of the feedback amplifier, which varies in response to a change in the molten metal level, the tool comprising:
virtual level plate holding devices each configured to hold a virtual level plate and respectively disposed at height positions separated with a predetermined interval pitch, which divide a length from a lower end position of the detection head to a measurement lower limit of the detection head; and
a plurality of virtual level plates configured to be placed respectively at the height positions separated with a predetermined interval pitch such that gaps between themselves and each wide face of the mold are not larger than 2 mm respectively at the height positions,
so as to carry out calibration while using each of the virtual level plates at a corresponding one of the height positions.
